(19) United States
(12) Patent Application Publication
(10) Pub. No.: US 2012/0141644 A1
(43) Pub. Date: Jun. 7, 2012

(54) Germ Oil Extraction With Ethanol

(76) Inventors: Munir Cheryan, Urbana, IL (US); Philip Shane, Hudson, IL (US); Felipe Arana, Urbana, IL (US)

(21) Appl. No.: 12/961,040

(22) Filed: Dec. 6, 2010

(51) Int. Cl. A23D 9/00

(52) U.S. Cl. 426/417

(57) ABSTRACT

A corn oil production method is described that produces oil from corn germ. An alcohol solvent is used to extract oil from corn germ. The extraction mixture is separated into the deoiled germ solids and an extract containing the alcohol solvent and oil. The extract is membrane filtered by nanofiltration or reverse osmosis. The oil is retained in the retentate and the alcohol solvent passes into the permeate. The oil contained within the retentate is concentrated and purified. The alcohol used in the extraction step may be produced in-house. The de-germed corn and the de-oiled germ solids may be used to produce the alcohol.

### BACKGROUND OF THE INVENTION

1. Field of the Invention

The present invention relates generally to a process for extracting oil from corn germ. More specifically, the invention relates to using an alcohol solvent to extract oil from the corn germ. The alcohol used to extract the oil may be produced in-house.

2. Background

The corn-based industry is rapidly expanding, but faces the problems of high corn prices and an oversupply of dried distiller's grains with solubles (DDGS), which may affect the future economic viability of the industry. Thus, the need exists to derive high-value co-products for the ethanol industry.

Corn contains about 4% oil, most of which is present in the germ. Corn oil is commonly produced by wet milling that involves steeping or soaking the corn in a dilute solution of lactic acid and sulfur dioxide followed by grinding of the hydrated corn to separate the germ from the endosperm. The germ is then washed and separated in a series of hydrocyclones, pressed to remove excess moisture and processed in an oil extraction and refining plant, usually with hexane (a toxic solvent) as the extraction solvent.

Although wet milling is the most common method, it suffers from some limitations, including the long process times, potential loss of oil (typically about 15% of the oil that is in the endosperm is not recovered) and relatively high operating costs due to the energy required to dehydrate the steep water.

Dry milling and dry-grind are much simpler processes, requiring substantially less investment of capital and with lower operating costs. However, corn oil is not produced by dry milling or dry-grind ethanol plants and is lost in the DDGS. The literature indicates that corn germ contains 20-30% oil when separated by dry milling and 45-50% oil by wet milling.

The need exists for new and existing ethanol plants to increase their revenue by developing a diversified product line to offset the higher cost of corn and other inputs. Fractionation of whole raw corn at the front end of a dry-grind plant into germ, endosperm and bran has been proposed. The germ, which contains valuable oil, is sold to corn oil processors. However, the price of corn germ is low depending on germ composition. While the price for germ may be better than that for DDGS, fractionating results in a loss of starch of up to 20% and 10-20% of the protein in the kernel. Additionally, there are very few germ processors that have the additional capacity to handle large amounts of germ from dry-grind ethanol plants that practice fractionation.

The ability to isolate the oil from the germ on-site, thus eliminating the need to sell the germ itself to corn oil producers, provides ethanol producers an opportunity to increase their revenue. Additional benefits result from the removal of oil from the germ. Lowering oil in DDGS produces better feed for ruminant animals, allowing for higher inclusion rates of DDGS in their diet and reduces the incidence of soft belly fat in swine.

In addition, the need exists for reducing harmful byproducts in ethanol plants. Removal of oil reduces VOC (volatile organic compounds) emissions from DDGS dryers (oil is the main source of emissions). This may substantially reduce the operating cost of thermal oxidizers, or even completely eliminate them.

Other benefits of removing the oil include better plant operations by minimizing plugging of equipment, a possible increase in fermentor capacity, and increase in DDGS dryer capacity and improved flowability of DDGS during rail car transportation.

Thus, the need exists for an efficient process to remove oil from corn germ. Further value is added to the process because ethanol produced in-house at the ethanol plant is used to extract the corn oil.

### SUMMARY OF THE INVENTION

The method of the present invention uses an alcohol as a solvent to extract oil from separated corn germ, followed by the use of membrane technology to filter the oil. Alcohol is the only reagent utilized by the process, and conventional dry-grind and wet mill ethanol plants therefore already provide the necessary reagent supply for implementation of the invention, though alcohol from any source may be used.

The invention may serve as the basis for an add-on technology to an existing dry-grind or wet mill plant, as well as the basis upon which new dry-grind and wet mill ethanol plants are constructed. Dry-grind plants are likely to benefit significantly from the present invention since the invention provides ways to produce a high-value co-product from the corn while making use of in-house equipment, raw materials and products.

A corn-based plant modified or constructed to implement the preferred embodiments of the present invention may use alcohol solvent containing a high concentration of ethanol, typically 90-100% ethanol, to extract oil from the corn germ. Membrane filtration may be used to concentrate the oil and recover the ethanol solvent for further use in processing, if desired. Recycled ethanol solvent may be used in additional extraction of oil or may be processed by distillation if ethanol is also a product of the plant. Further, the de-germed corn could be used in the ethanol plant to produce the ethanol solvent used for the extraction process, or to produce an ethanol product.

Generally, in a process for removing oil from germ, including corn germ, an ethanol solvent with a concentration in the range of from about 90% to about 100% ethanol and 0-10% water is mixed or brought into contact with the corn germ to form an extraction mixture consisting of the ethanol solvent, oil, other components of corn co-extracted by the ethanol solvent and the remaining corn solids. The extraction mixture is separated into the corn solids and an extract. The extract includes the ethanol solvent, oil and co-extracted components. The extract is membrane filtered by nanofiltration or reverse osmosis to retain the oil and a portion of the ethanol solvent in the retentate and pass the remaining ethanol solvent into the permeate. The oil contained in the retentate is further concentrated and purified.

An object of the present invention is to provide a method of extracting oil from corn germ.

A further object of the present invention is to provide a method of extracting oil from corn germ using an alcohol solvent, including ethanol, as the sole reagent.

Another object of the present invention is to provide a method of extracting oil from corn germ making use of basic dry-grind ethanol plant equipment and products of conventional dry-grind ethanol plants.

These and other objects of the present invention will become apparent to those skilled in the art upon reference to the following specification, drawings, and claims.

### BRIEF DESCRIPTION OF THE DRAWINGS

FIG. 1 illustrates the corn oil production process of the present invention.

FIG. 2 is a graph showing the effect of solvent to solids ration on yield of oil in the extract.

FIG. 3 is a graph showing the effect of solvent ration and moisture content of germ on total solids and oil concentrations of extracted oil.

FIG. 4 is a graph showing the effect of germ moisture content on oil yield and purity.

FIG. 5 is a graph showing the effect of germ moisture content on moisture content of spent ethanol.

FIG. 6 is a graph showing the effect of extraction time on oil yield and purity.

FIG. 7 is a graph showing the effect of extraction temperature on oil yield and purity.

FIG. 8 is a graph showing the effect of extraction temperature on total solids and oil concentration.

FIG. 9 is a graph showing yield and purity of germ extracted multiple times.

FIG. 10 is a graph showing the effect of pre-drying the germ on total solids, oil and moisture concentrations in combined extracts.

FIG. 11 is a graph summarizing the effect of wet and dry germ on yield and purity.

FIG. 12 is a graph showing total solids, oil and protein in combined extracts.

FIG. 13 is a graph showing the relationship between oil, protein, and total solids.

FIG. 14 is a graph showing the effect of germ particle size on oil yield and purity.

FIG. 15 is a schematic representation of membrane work used in the present invention.

FIG. 16 is a graph showing the conditioning of two selected membranes.

FIG. 17 is a graph showing the flux of germ oil extracts using a selected membrane.

FIG. 18 is a graph showing the total solids of germ oil extracts using a particular membrane.

FIG. 19 is a graph showing membrane cleaning data.

FIG. 20 is a graph showing the flux of germ oil extracts using a selected membrane.

FIG. 21 is a graph showing the total solids of germ oil extracts using a particular membrane.

FIG. 22 is a graph showing membrane cleaning data.

FIG. 23 is a graph showing the relationship between retentate and permeate solids concentrations during membrane processing.

FIG. 24 is a graph showing the stability of a particular membrane.

FIG. 25 is a graph showing the stability of a particular membrane.

### DETAILED DESCRIPTION OF THE INVENTION

The invention extracts oil from corn germ using an alcohol and uses membrane filtration to concentrate the oil and recover the alcohol. The sole reagent used in the process is an alcohol solvent, which may be recycled for use in additional extraction or may be used to produce an alcohol product. The de-germed corn is processed to produce the alcohol. The alcohol produced from the de-germed corn can be used as an alcohol product, or can be used to extract oil from the germ. The alcohol may be ethanol or isopropanol either alone or in combination with each other and/or in combination with water.

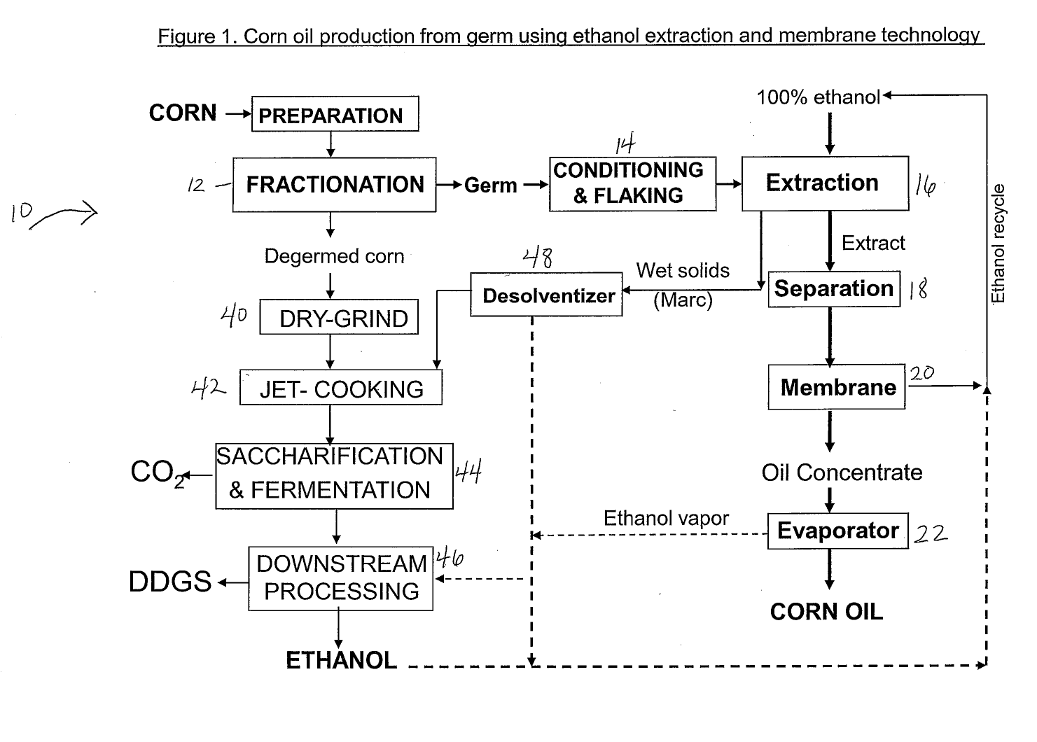

FIG. 1 shows a flow chart of an oil extraction method 10 of the present invention. Raw whole corn is prepared for use in the method by fractionating 12 the corn using any fractionation method. The fractionation method 12 may include the steps of conditioning the corn and separating the germ from the whole corn by a series of milling and separation steps. The germ may then undergo a conditioning or flaking process 14, although this step is not required. The moisture content of the germ is preferably 0-14% by weight. The germ is then extracted 16 with the alcohol solvent. This extraction step 16 preferably uses ethanol of approximately 90-100% concentration. However ethanol extraction 16 at 90% ethanol is inefficient and at least a 95% concentration is preferred. Drying the corn to reduce its moisture content and using moisture-free ethanol improves the yield and purity of the oil obtained through this process. The extraction step 16 may be conducted in a batch or continuous mode.

The alcohol is preferably supplied by the plant conducting the process of the invention, and since it may be one of the corn products produced by the plant conducting the process, a self sustaining supply may be provided by the plant. No other reagent is required. The temperature of extraction should be 30-90° C., preferably close to the boiling point of the alcohol (78° C. if 100% ethanol is used). One of skill in the art will understand that the extraction may be carried out at any temperature in this range. The time of extraction may be 10 to 180 minutes, and preferably 30-60 minutes. One of skill in the art will understand that the extraction may be carried out for any length of time in this range and that the extraction may be carried out for a length of time longer than 180 minutes, with little or no improvement over the preferred time in terms of oil quantity or purity.

A separation step 18, such as centrifugation or filtration or gravity settling, is conducted on the extraction mixture. The objective of the separation step 18 is to remove substantially all of the suspended non-extracted, de-oiled germ solids resulting in a clarified extract containing alcohol solvent, oil and other co-extracted alcohol-soluble components such as the corn protein zein. The extract may require a subsequent filtration or clarification to meet the requirements of the membrane filtration step, which is known to one of ordinary skill in the art.

The clarified extract is then processed in a nanofiltration 20 or reverse osmosis step using a membrane that will retain oil while allowing the alcohol solvent to pass through. Corn oil has a molecular weight of about 800-900 daltons. Selection of an appropriate membrane is therefore straightforward. Nanofiltration or reverse osmosis membranes that are stable in alcohol, such as those made by Dow, GE, Koch or PCI can be used. The retentate from this step 20 is corn oil concentrate while the permeate-containing alcohol solvent is recycled back to the extraction step 16 of the process. Alternatively, the permeate may be processed to make an alcohol product.

If necessary, the filtrate from step 18 can first be passed through an ultrafiltration membrane that will retain the zein and other co-extracted components that are larger than the oil in molecular size while allowing the alcohol solvent and oil to pass through into the permeate. This ultrafiltration retentate can be further processed to produce zein as a separate product and the alcohol in the retentate recycled back to the alcohol production section. The ultrafiltration permeate now contains mostly oil and alcohol solvent, which can go to the nanofiltration 20 or reverse osmosis step as described earlier.

The retentate of the nanofiltration or reverse osmosis operation in step 20 contains concentrated oil in the alcohol solvent and may be subjected to evaporation in step 22 to produce corn oil, while the alcohol vapors from the evaporation are recycled to the alcohol production section or used for extraction.

The separated germ solids are subjected to a desolventizing step 48 to remove any alcohol that may be absorbed in the germ solids. The alcohol recovered from the desolventizing step is recycled to the distillation section of the plant or used for extraction 16. The desolventized germ solids may be added to the de-germed corn, whole corn, or other corn byproducts and processed to produce alcohol.

Depending on the moisture content of the corn and the manner in which the plant is operated, the alcohol solvent used as the extractant may absorb water during the extraction, filtration and membrane processing steps. This water must be removed from the alcohol recycle streams to maintain its effectiveness for extracting oil. This can be done either by distillation as, for example, in a separate distillation column or, if the plant is a corn-based ethanol plant, in the distillation section of an ethanol plant. Water can also be removed from the recycle alcohol stream by another membrane technology known as pervaporation. In any case, the alcohol must be adjusted to within 90-100% alcohol concentration prior to being used in the extraction step 16. The alcohol in the extraction step 16 may be prepared in-house. In one embodiment, the de-germed corn solids from fractionation step 12 are processed to produce ethanol. In one example, the de-germed corn solids are jet cooked 42, subjected to saccharification and fermentation 44 and then subjected to downstream ethanol processing 46 to create DDGS and ethanol. That ethanol can be used as the extraction solvent in the germ oil extraction process or prepared as an ethanol product.

It will be understood by one of skill in the art that preparation of alcohol or ethanol in particular may start from de-germed corn, whole corn, or any other corn byproduct. In addition, the enzyme step of liquefaction may be carried out by cold hydrolysis or high-temperature jet cooking, depending on the process used by the ethanol plant.

The process of this invention results in little to no loss of starch, protein or ethanol. The oil is obtained using a “green,” nontoxic renewable extractant instead of a petroleum-based solvent. Oil obtained through this process may be sold directly to oil marketers and refiners instead of selling germ at a discount.

The process of this invention results in substantially all of the oil in the corn germ being extracted. Membranes are used to concentrate the oil and recycle most of the alcohol solvent, thus substantially reducing energy costs for producing crude corn oil.

### Example 1

Dry-fractionated germ was used. The germ assayed 14% moisture, 18.3% oil and 13.8% protein as shown in Table 1. Starch contents as determined by an independent outside laboratory were (dry basis): corn 73.0%, germ 26.9%, bran 30.1%, and endosperm 85.9%. The germ was dried, ground and extracted with 100% ethanol. Several extraction variables were investigated: moisture content of the germ, particle size of the germ, solvent:solids ratio, time of extraction, temperature of extraction and number of stages in a multiple-stage extraction. The dependent variables were oil yield in the extract, residual oil in the deoiled meal, oil “purity” which is defined as the ratio of oil to the total solids in the extract, moisture content of the spent ethanol, loss of corn solids and protein in the extract, and concentrations of solids and oil in the extract.

TABLE 1
Proximate analysis of fractionated corn components

| | Analysis, as-is | | | | Dry basis | | |
|---|---|---|---|---|---|---|---|
| | Mois- | | Pro- | | | Pro- | |
| Fractions | ture | Oil | tein | Others* | Oil | tein | Others* |
| Whole corn | 13.0 | 3.78 | 7.91 | 75.3 | 4.35 | 9.09 | 86.5 |
| Germ | 14.0 | 18.3 | 13.8 | 53.9 | 21.2 | 16.1 | 62.6 |
| Bran | 14.5 | 5.85 | 9.31 | 73.8 | 6.84 | 10.9 | 86.3 |
| Endosperm | 14.9 | 1.05 | 6.26 | 77.8 | 1.24 | 7.36 | 91.4 |

*By difference: Starch + fiber + ash

For the experiments described here, the largest and most uniform pieces of germ were manually selected from the bulk supply. Prior to grinding, the moisture content of the germ was adjusted by drying in an air-convection oven at 120° C. to various levels.

Ethanol (200 proof; USP grade) was procured from Aaper Alcohol and Chemical Co. (Shelbyville, Ky.). The water used was distilled and then microfiltered using Pall 0.2 μm Maxi Capsule Filter (Pall Gelman Lab, Ann Arbor, Mich.).

### Methods

### Grinding of Germ

The germ was ground using a bench top hammer mill (IKA MF 10.2, IKA Works Inc., Wilmington, N.C.) fitted with 2 mm pore screen. Because of the high fat content, this grinder generated considerable heat during grinding which required frequent stops to allow the grinder to cool. Subsequently, the germ was ground first in a Wiley mill fitted with a ⅛″ screen and then ground in the IKA grinder. One series of experiments studied the effect of particle size. Different particle sizes were obtained with germ ground with the Wiley mill followed by the IKA grinder with three screens of 1 mm, 2 mm and 3 mm.

### Extraction

Batch extractions were performed with 500-1000 mL Erlenmeyer flasks and a hot plate with a magnetic stir bar. The system is enclosed using plastic film or aluminum foil and also fitted with a cold water condenser if needed to minimize ethanol vapor loss. All experiments were conducted with 40 grams of ground germ. The proper volume of ethanol was prepared for the desired solvent-to-solids ratio (milliliters of solvent to grams of solid). Example: for 2:1 ratio, 80 mL of ethanol was used. For 4:1 ratio, 160 mL of ethanol was used. The ethanol was added to the extraction flask and the ethanol preheated to the extraction temperature. Forty grams of ground germ was added to the hot ethanol slowly. The mixture was stirred for the desired amount of time (e.g., 60 minutes).

The germ-ethanol slurry was filtered using Whatman filter paper No. 1 with a mean pore size rating of 11 μm. The volume of filtrate recovered was recorded.

The de-oiled germ (filter cake) was dried and its weight recorded.

Samples were kept in enclosed bottles at 4° C. for analysis.

### Experimental Design

The experimental design, the ranges and levels of variables are shown in Table 2. These were selected based on preliminary trials and our previous experience with corn oil extraction from whole corn and DDGS. Experiments A through D are single batch extractions, i.e., the germ was extracted one time under specified conditions. Experiment E is a multiple extraction experiment, wherein the germ was re-extracted multiple times with fresh ethanol each time in an effort to extract all the oil from the germ. Each re-extraction was conducted under the same conditions of solvent-to-solids, temperature, time, etc. Since the extracted germ in our bench-top experiments was retained on the filter paper, the germ was scraped off the filter paper carefully and added directly to preheated ethanol for the second stage.

Experiment F studied the effect of moisture content of the germ on extractability of the oil. The germ was dried to varying extents by placing it in a forced air oven at 80° C.

### Analytical Methods

Total solids were determined by oven-drying after the ethanol was evaporated under ambient conditions in a hood. Protein was measured by the Dumas Method using a Leco FP528 nitrogen analyzer and is expressed as N×6.25. Moisture of ethanol was measured by the Karl Fisher method and oil was measured by Soxhlet.

TABLE 2
Experimental design for extraction of corn oil from dry-fractionated germ

| | | Ratio | | | Number of | Particle |
|---|---|---|---|---|---|---|
| Expt. | | (mL EtOH per | Temp. | Time | extractions | size (mm |
| Number | VARIABLE | g germ) | (° C.) | (min) | of germ | size screen) |
| A | Ethanol to | 2, 4, 6, 8 | 50 | 60 | 1 | 2 |
| | solids ratio | | | | | |
| B | Time | 4 | 50 | 30, 60, | 1 | 2 |
| | | | | 120, 180 | | |
| C | Temperature | 4 | 40, 50, | 60 | 1 | 2 |
| | | | 60, 70 | | | |
| D | Particle size | 4 | 50 | 60 | 1 | 0*, 1, 2, 3 |
| E | Multiple | 4 | 50 | 60 | 1, 2, 3, 4, 5 | 2 |
| | extractions | | | | | |
| F | Germ Moisture | 4 | 50 | 60 | 1, 5 | 2 |

*No grinding of germ; germ used as provided by the ethanol plant

### Effect of Solvent-to-Solids Ratio

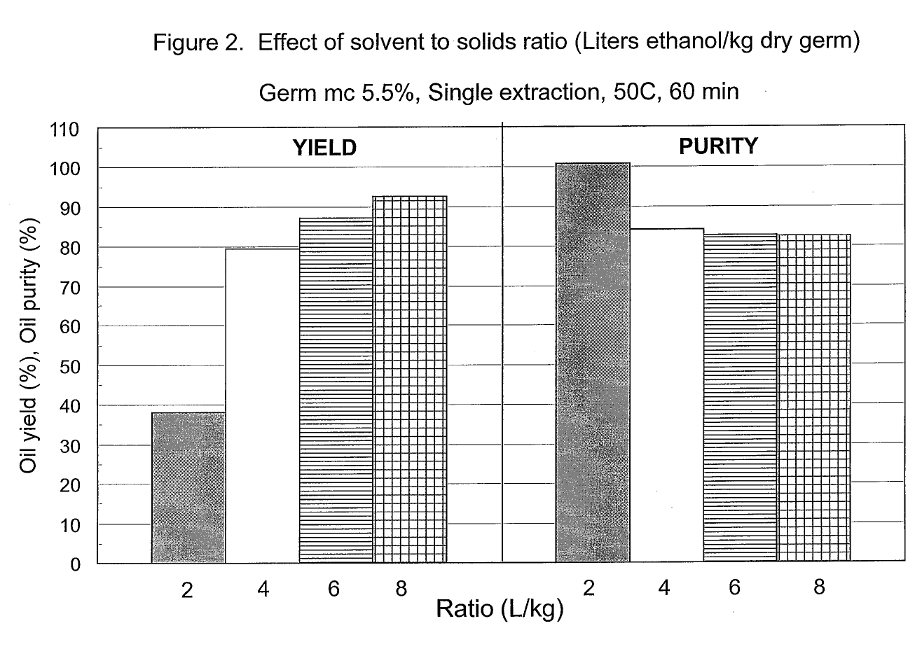

FIG. 2 shows the effect of solvent to solids ratio on yield of oil in the extract where yield was determined as:

Oil Yield (%)=100×(mass of oil in the extract/mass of oil in the germ)

Protein and oil in the solid samples (germ, de-oiled meal) could be determined by standard methods. However, protein could not be determined in the liquid samples (the extract), even after drying, due to their high oil contents. Oil could not be determined since it was a liquid and due to small volumes. Thus the oil and protein in the extract were determined by a material balance:

Mass of oil in the extract=Mass of oil in germ−mass of oil in germ meal

Mass of oil in germ=Mass of germ (dry basis)*oil content of germ (dry basis)

Mass of oil in meal=Mass of meal (dry basis)*oil content of meal (dry basis)

Oil content of extract (d.b.)=Mass of oil in extract/mass of total solids in extract

Mass of total solids in extract=Total solids in extract (w/w)*Weight of extract

Weight of extract (kg)=Volume of extract (L)*density of extract (kg/L)

Density of extract=0.8 kg/L

An increase in yield is observed with an increase in the amount of solvent used, approaching an asymptotic value close to 95% of the oil in the germ at high ratios (FIG. 2). In contrast, the oil “purity” decreases with higher solvent ratios, indicating that excess solvent is extracting a greater proportion of non-oil components. Both high yields and high purities are desirable; the latter because it will reduce refining costs.

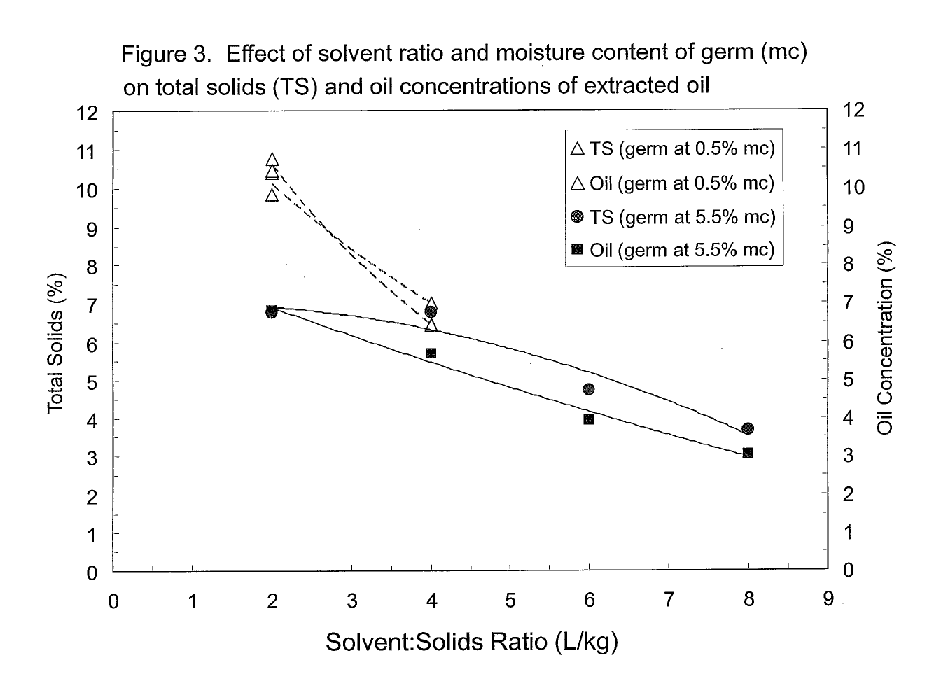

FIG. 3 shows the inverse effect of solvent ratio on concentration of oil and solids in the extract. Although high concentrations are desirable to reduce subsequent desolventizing costs, the yield is too low at low solvent ratios. It appears that a solvent ratio of 4 is a good compromise.

### Effect of Moisture Content of Germ

High initial germ moisture content (mc) significantly reduces the efficiency of extraction

(FIG. 3) especially at low solvent ratios. Ethanol is a known dehydrating agent, and the moisture transports from the germ into the ethanol. The final moisture content of the ethanol depends on the ratio of solvent to solids in addition to the moisture content of the germ. High moisture in the extraction (and spent) ethanol has two negative effects: (1) It lowers the solvating power of the ethanol, and (2) It results in high ethanol dehydration costs. Subsequent studies were done with the germ at <1% moisture.

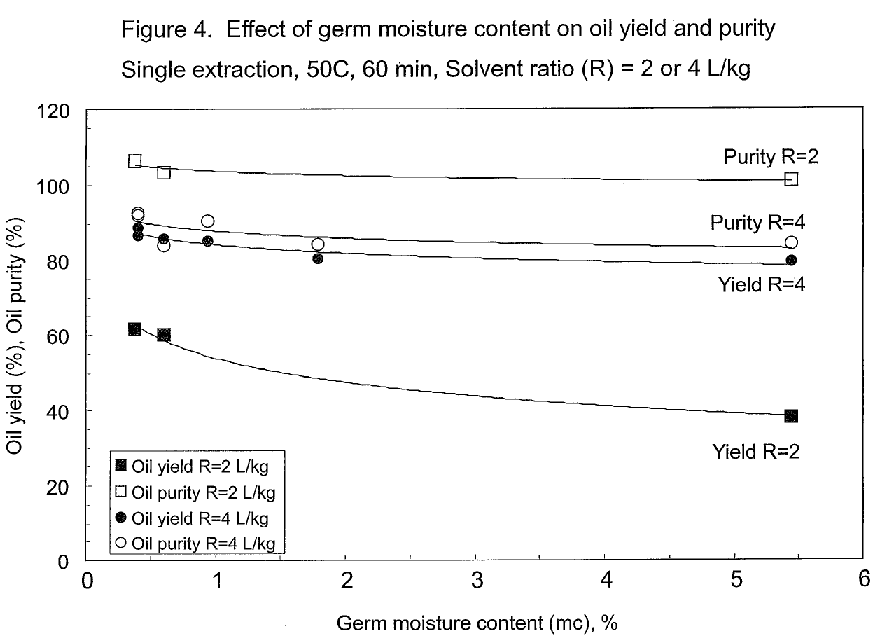

FIG. 4 shows the detrimental effect of germ moisture content on oil yield and purity and the strong interacting effect of the solvent-to-solids ratio (R) on these parameters. The effect on yield is much worse at low R values, while the effect on purity is worse at high R values.

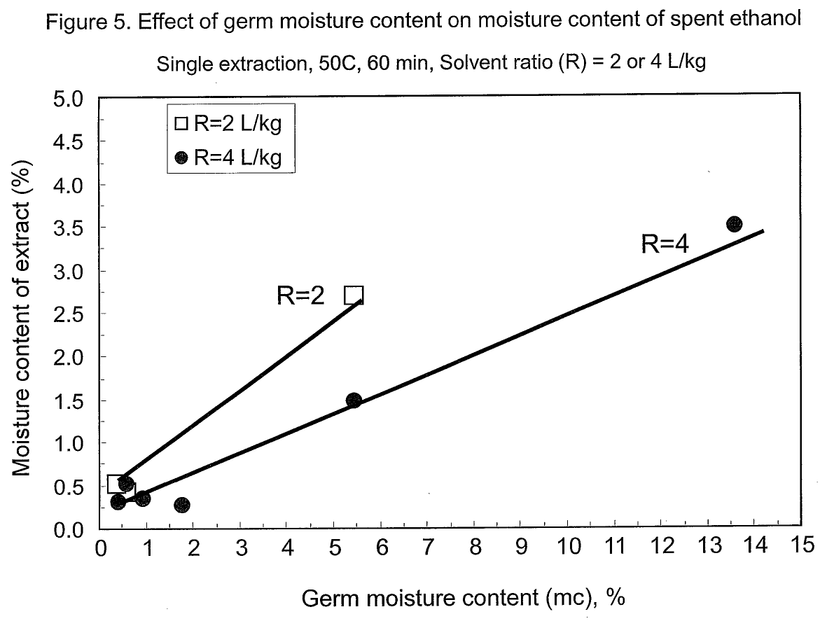

FIG. 5 shows the effect of germ moisture content and solvent ratio (R) on moisture content of the extract and, by implication, in the spent ethanol which will be recycled to the extractor. There is an almost linear relationship between these two moisture parameters, as expected. However, for the same initial germ moisture, lower R values result in higher moisture content of the extract. This is because water transfers from the germ into a smaller volume of ethanol, resulting in higher concentration of water in the extract. These contrarian effects of germ moisture and solvent ratios on these three important process parameters (yield, purity and oil concentration in the extract) indicate that these variables must be carefully and optimally selected.

### Extraction Time

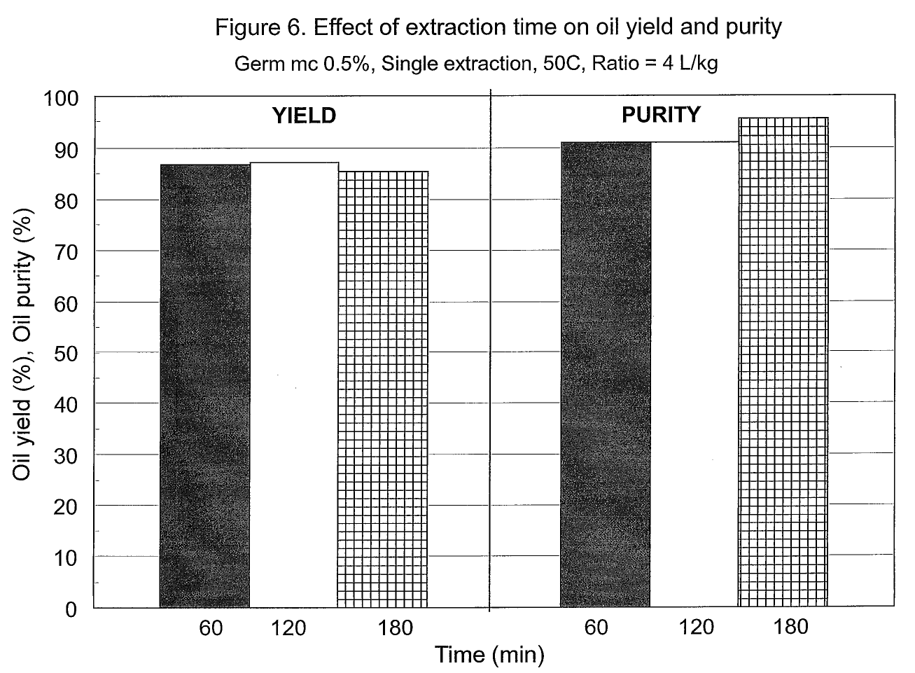

FIG. 6 shows that extraction time above 60 minutes did not have a significant effect on yield or purity.

### Extraction Temperature

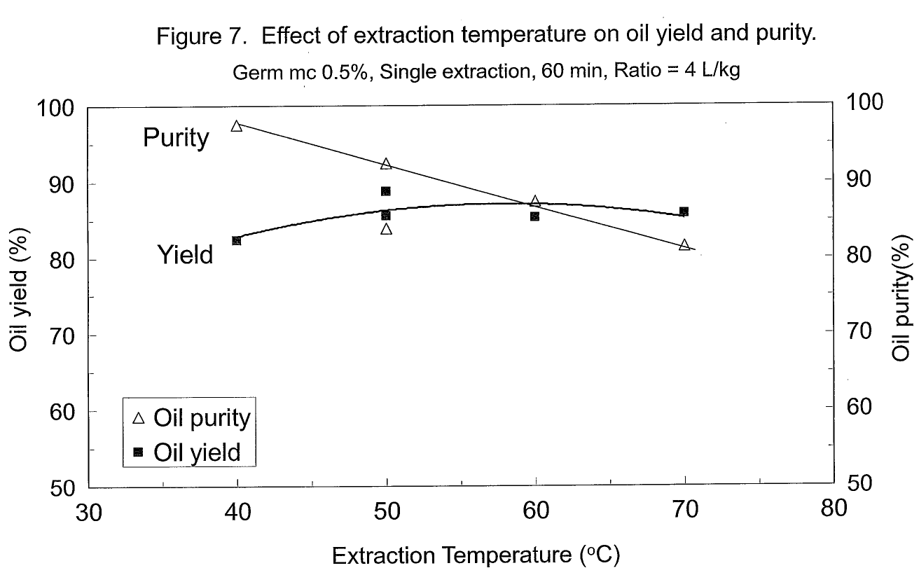

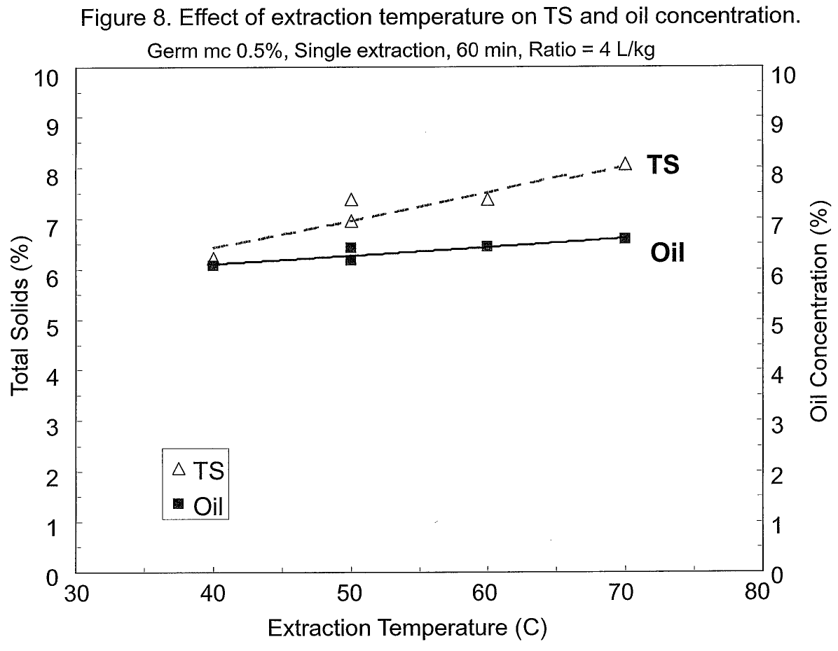

There is a small effect of extraction temperature on oil yield (FIG. 7) and concentration of oil (FIG. 8), but a large effect on purity (FIG. 7) and concentration of total solids (FIG. 8), indicating that higher temperatures are extracting more non-oil components. A temperature of 50° C. appears to be a good optimum.

### Multiple Extraction of Germ

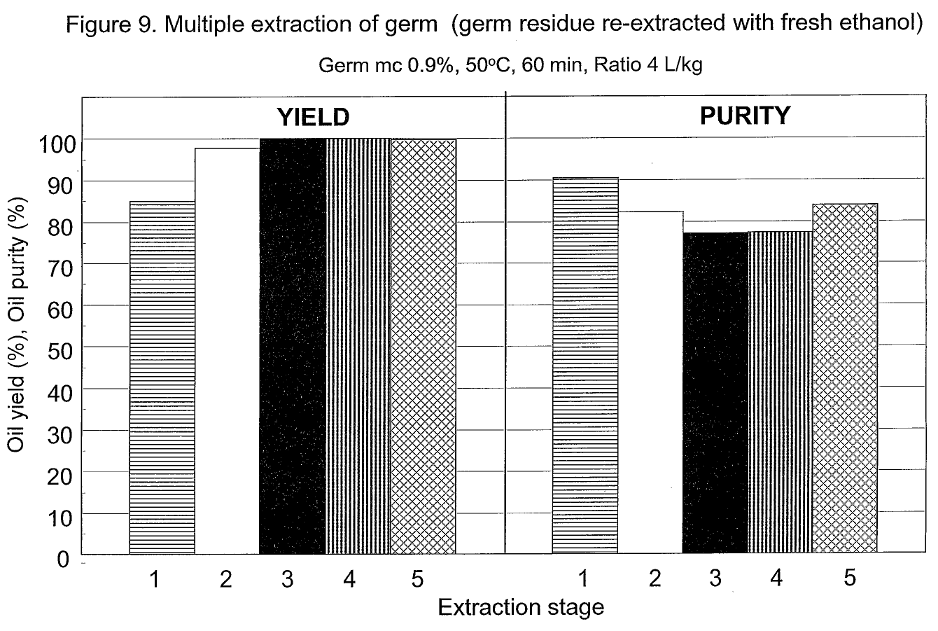

FIG. 9 shows multiple extractions of the germ with fresh ethanol. Stage 1 was the conventional extraction, resulting in an oil yield of 85% and purity of 90%. The germ-ethanol slurry was filtered and the wet filter cake (i.e., the partially deoiled meal) was extracted again in stage 2 with an equal volume of fresh 100% ethanol. After filtration, the de-oiled meal was again re-extracted with fresh ethanol in stage 3, and so on for five stages. Three stages are apparently enough to result in essentially 100% yield of oil.

However, the purity of the extract decreased to 77% in the third stage, indicating that the fresh ethanol was re-extracting mostly non-oil components from the germ. In addition, the concentration of oil in the combined extracts decreased resulting in higher oil refining costs with more stages. A continuous extractor may be used to obtain more optimal results, i.e., high yields, acceptable purity and high concentration of oil in the extract.

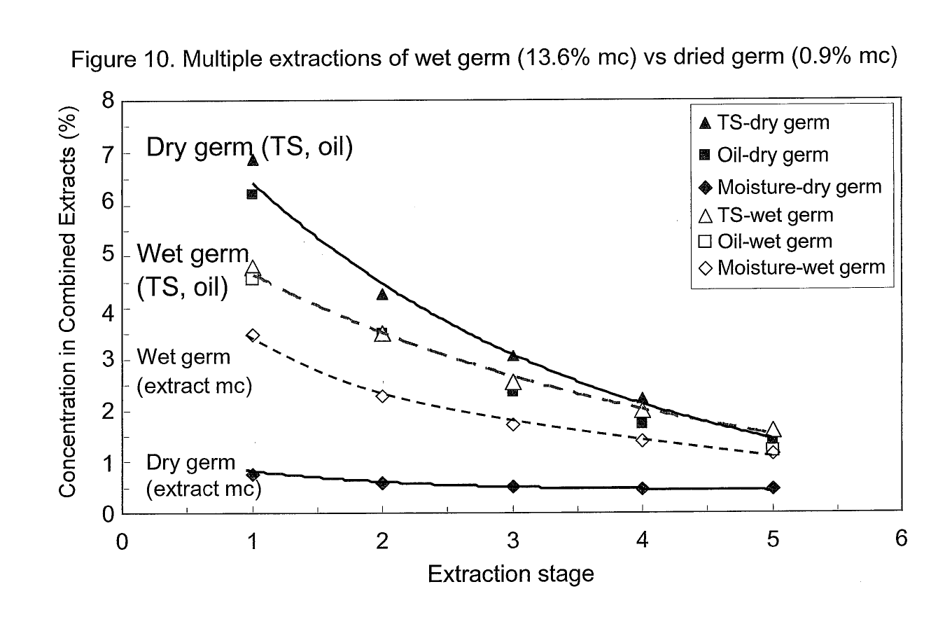

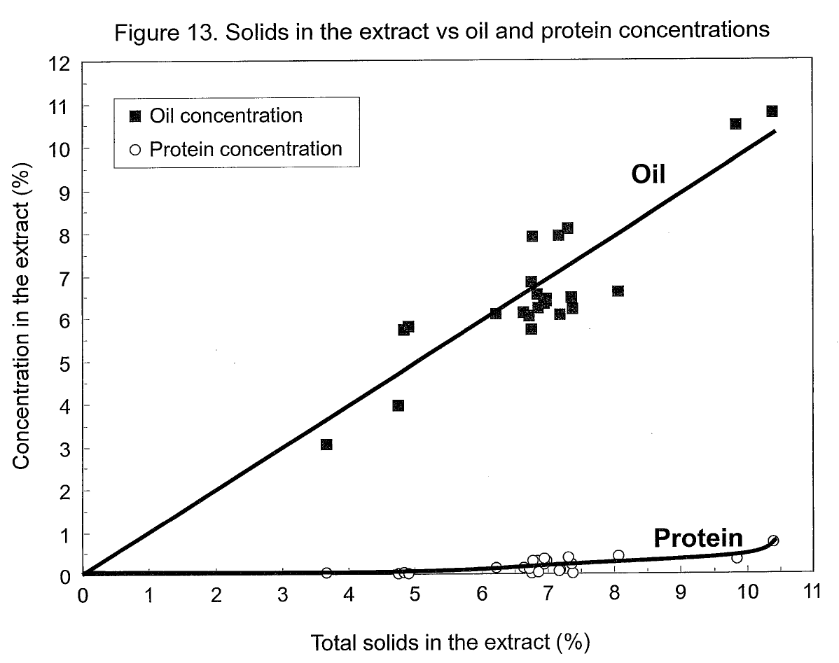

FIG. 10 shows the effect of pre-drying the germ on total solids, oil and moisture concentrations in the combined extracts [“Combined extracts” is all the extracts from each stage pooled together, e.g., “Extraction Stage 3” extract contains the extracts from stages 1, 2 and 3. The assumption is that a continuous extractor would be used in a large-scale commercial facility that would simulate all stages of a batch extraction, resulting in only one extract being produced, which is the equivalent of “combined extracts” from a batch operation.]. Dried germ would not cause much water transfer to the ethanol, thus maintaining the solvent power of the ethanol, resulting in higher levels of oil in the extract compared to using wet germ. On the other hand, wet germ would cause an immediate moisture transfer to the ethanol and lower its solvent power. The difference between wet and dry germ would diminish in subsequent stages of a multi-germ extraction process, since the earlier stages would pull out much of the water from the germ, thus increasing solvation power of the ethanol in the later stages. This phenomenon is shown in FIG. 13. Note that the amount of moisture in the combined extracts decreases in later stages.

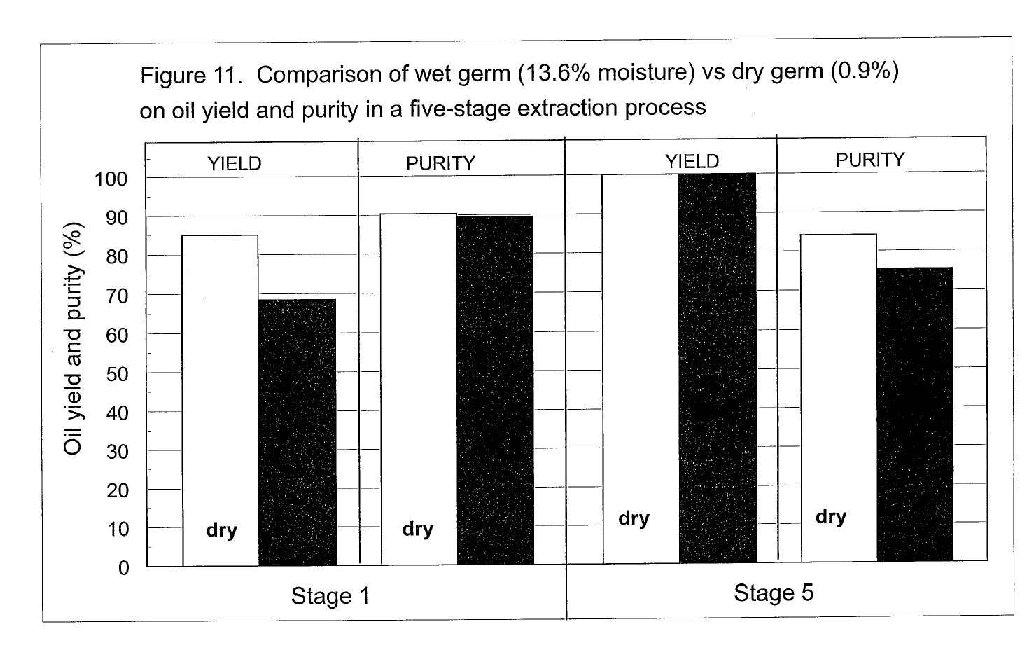

FIG. 11 summarizes the effect of wet and dry germ on yield and purity (which are different parameters than concentrations shown in FIG. 10). In earlier stages, there is a difference in yield, but not in purity, between wet and dry germ. In later stages, there is no difference in yield (both wet and dry germ give essentially 100% oil yields with five stages), but the purity decreases, perhaps more so with the wet germ than the dry germ (this particular data needs to be replicated again to confirm this trend).

### Protein Co-Extraction

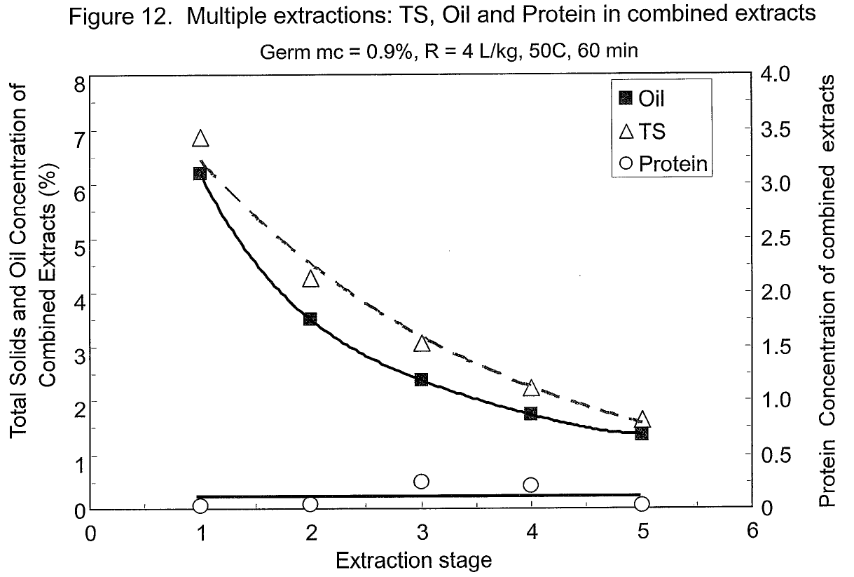

FIG. 12 shows that protein (probably zein) co-extracts with the oil. Because protein is impossible to determine by the Dumas method in the presence of such overwhelming amounts of oil in the sample, the protein in the extract was determined by mass balance, comparing the protein contents of the original germ with the de-oiled germ in each stage. Protein levels are low (<0.3% compared to total solids levels of 1.5-7%) with no definite trends.

FIG. 13 shows the relationship between oil, protein and total solids. Data from several experiments were combined in this plot to show general trends. Conditions that result in low levels of oil and total solids generally result in negligible levels of protein. However, attempting to maximize yield of oil also pulls out non-oil components simultaneously, including an increase in protein at high oil levels.

### Effect of Particle Size

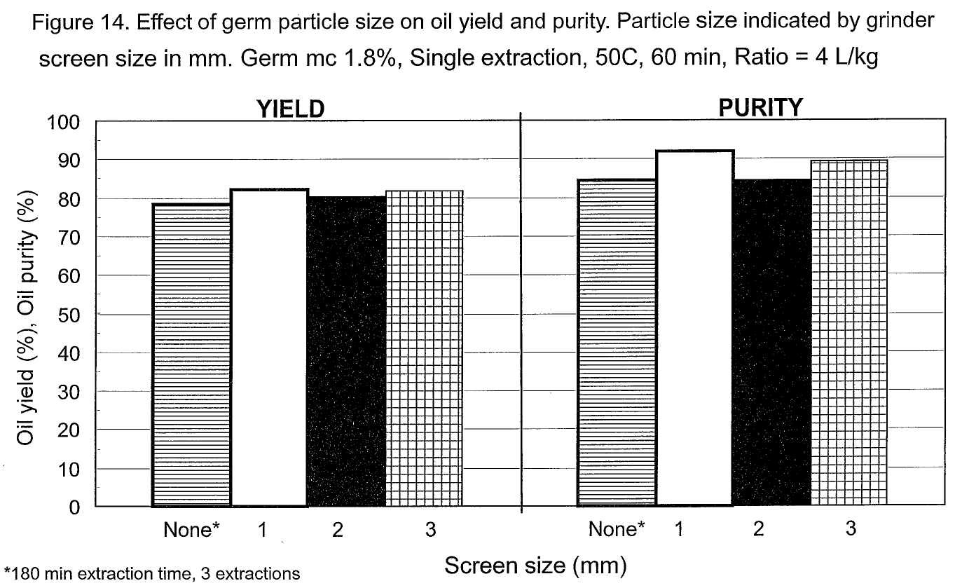

FIG. 14 shows that particle size within the range studied had little or no effect on the yield of oil and oil purity. Although the germ could be used as-is, with no size reduction at all, it would require three times as much time and ethanol as compared to using germ with even a coarse grinding. However, if germ is to be ground or flaked before extraction, care must be taken to minimize lipolysis (enzyme degradation of the oil) or auto-oxidation due to increased exposure to air.

### Membrane Separation of Oil Extract

Membranes were identified that could be used to separate and concentrate the oil with the objectives of (a) reducing the energy needed to evaporate the ethanol solvent to produce crude corn oil, and (b) recycling the ethanol solvent. The measured variables are flux and rejection of oil and total solids.

### Membrane Selection

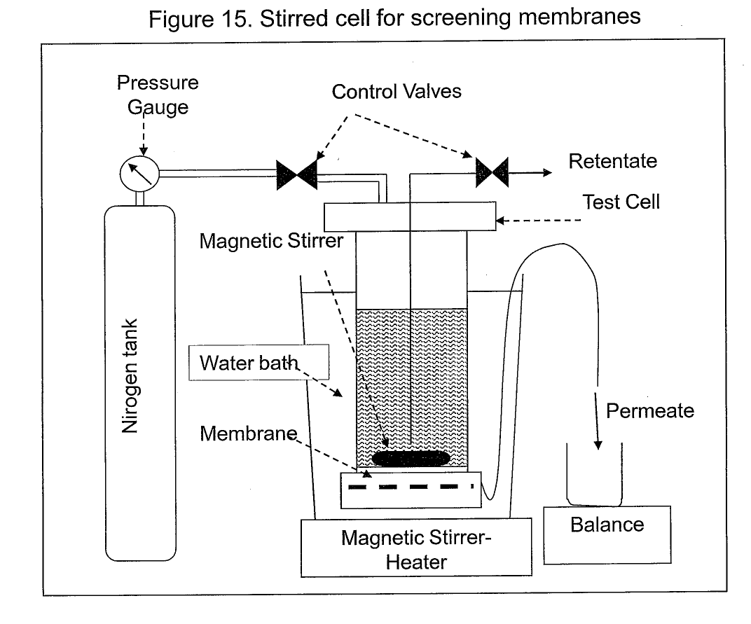

The purpose here was to screen membranes for the separation and isolation of oil from the extract. Initial experiments were done with model systems of corn oil in 100% and 95% ethanol. Many membranes that are adequate with aqueous systems cannot be used with organic solvents because membrane materials were incompatible with the solvent. Even those membranes that were relatively stable had to be conditioned prior to use. Membrane work in this example was done using a bench-top stainless steel cell shown schematically in FIG. 15. The cell was a SEPA-ST model membrane test cell (Osmonics Inc., Minnetonka, Minn.) with a magnetic stirrer and a nitrogen gas cylinder to provide pressure as the driving force for permeation. The cell is capable of withstanding pressures up to 6.9 MPa (1000 psig) and holds a 5 cm diameter membrane disc or “coupon” (effective membrane area of 17.35 cm²). Portable ethanol and deionized water microfiltered through a 0.2 μm filter were used in all experiments. Flux was measured by the time required to collect a desired volume of permeate. The test cell was held in a water bath to simulate test conditions at alternate temperatures.

The membrane coupons were conditioned by the method of Kwiatkowski and Cheryan (Recovery of corn oil from ethanol extracts of ground corn using membrane technology. Journal of the American Oil Chemists Society, volume 82, pp. 221-227, 2005; Performance of nanofiltration membranes in ethanol. Separation Science and Technology, volume 40, pp. 2651-2662, 2005). The membrane coupon was first rinsed under running deionized water. The coupon was then soaked in solvent overnight and placed in the test cell for the trial. The cell was filled with 150-200 mL of solvent and 10 minutes were allowed to reach the temperature of the surrounding water bath (if necessary). The system was pressurized to the desired pressure (1.38, 2.76, or 4.14 MPa) and liquid was permeated until the flux had reached a steady value. The membrane was removed after the trial and placed in the next solution of ethanol overnight and the procedure was repeated until 100% ethanol.

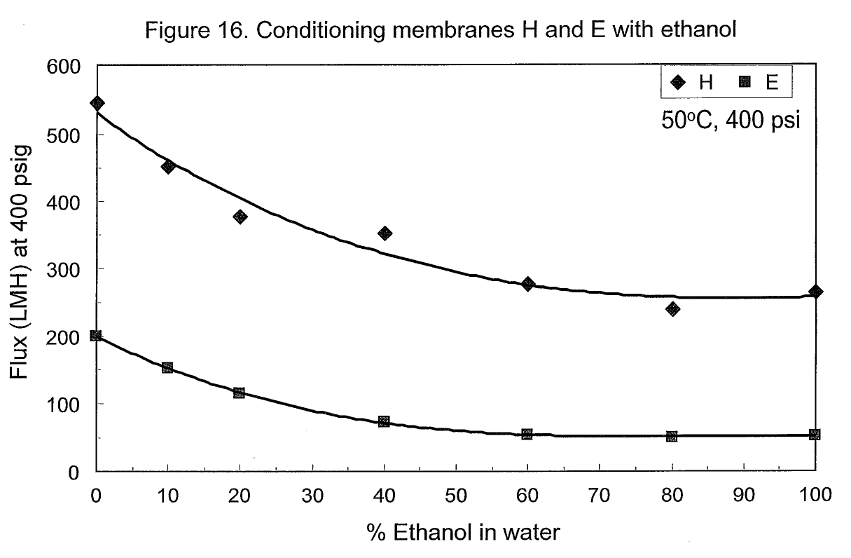

FIG. 16 shows typical conditioning data with two selected membranes. These membranes are of the general class of reverse osmosis/nanofiltration thin-film composite polymeric membranes. Exposure to ethanol results in a substantial decrease in flux, perhaps due to constriction of the pores caused by polymer swelling. Numerous coupons of each membrane were conditioned and several individual coupons with similar flux patterns were kept for the trials. These were labeled as “H1, H2, H3, . . . E1, E2, E3, . . . etc.”.

Corn oil extracted from germ as described herein were used to evaluate the performance of the selected membranes (Table 3). Extracts were membrane concentrated until the retentate volume approached the minimum holdup volume of the cell or when the flux became too low to be measured in a reasonable time. Flux was monitored throughout the experiment. Samples of feed, retentate and permeate were taken during runs and analyzed for oil, total solids and protein. After testing, the membrane was washed with 100% ethanol and soaked overnight. Flux with pure ethanol was determined again and compared with the pure ethanol flux that had been obtained before exposure to the oil extract.

TABLE 3
Total solids (%) of corn oil extracts
used as feed for membrane trials

| Extract # | Membrane H | Membrane E |
|---|---|---|
| 1 | 7.34 | 6.88 |
| 2 | 1.71 | 1.65 |
| 2(2) | 1.71 | — |
| 3 | 0.59 | 0.65 |

### Calculations

Flux (J, liters per square meter of membrane area per hour) is defined as:

$$J ( LMH ) = \frac{Volume of permeate ( L )}{Time ( hr )} \times Membrane surface area ( {m}^{2} )$$

Rejection (R) is defined as:

$$R ( \% ) = ( 1 - \frac{{C}_{P}}{{C}_{R}} ) \times 100$$

where Cₚ and C_{R} are concentrations of corn oil in permeate and retentate respectively.

Volume concentration ratio (VCR or X)=Volume of feed/volume of retentate

### Concentration of Corn Oil Extracts

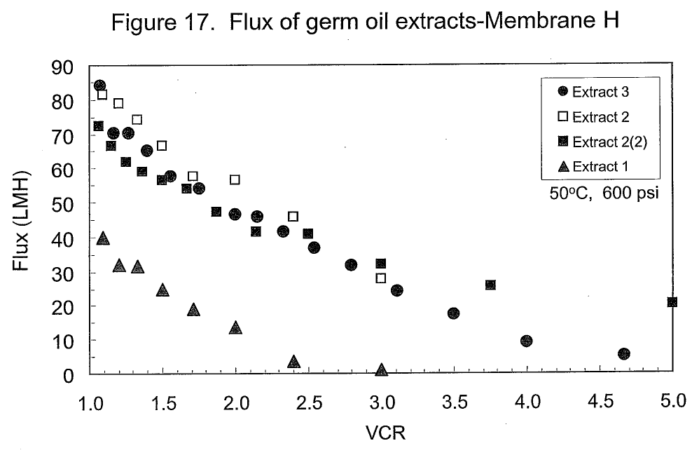

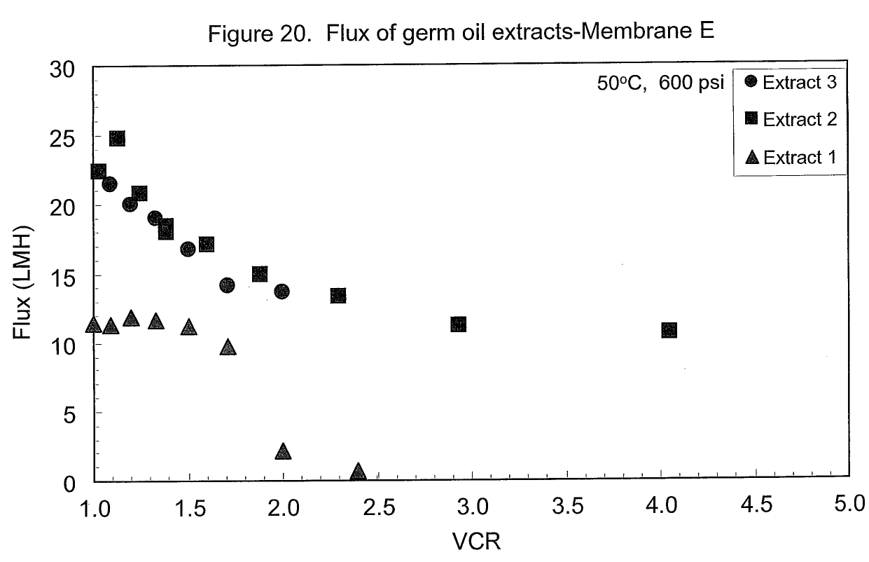

Several extracts were used as feedstock for the membrane trials. These are shown in Table 3 below. These were obtained from various multiple stage extractions as described earlier. The “total solids” value is mostly (>90%) oil. Results obtained with two of the membranes tested are shown here. FIGS. 17-19 are with Membrane H and FIGS. 20-22 are with Membrane E. FIGS. 17 and 20 show data obtained during concentration of the extracts from Table 3. Typical flux-concentration behavior is observed in that flux decreases with increasing concentration, probably in a semi-exponential manner. The concentrated extracts (#1) reached zero flux at VCR values of about 2.7-3, while the more dilute extracts could go to higher VCRs. Flux with Membrane H was three times higher overall than Membrane E.

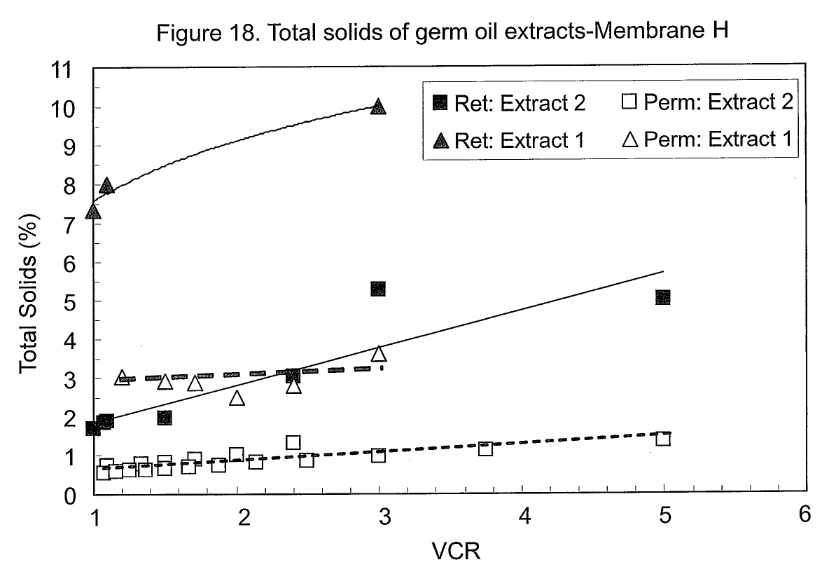

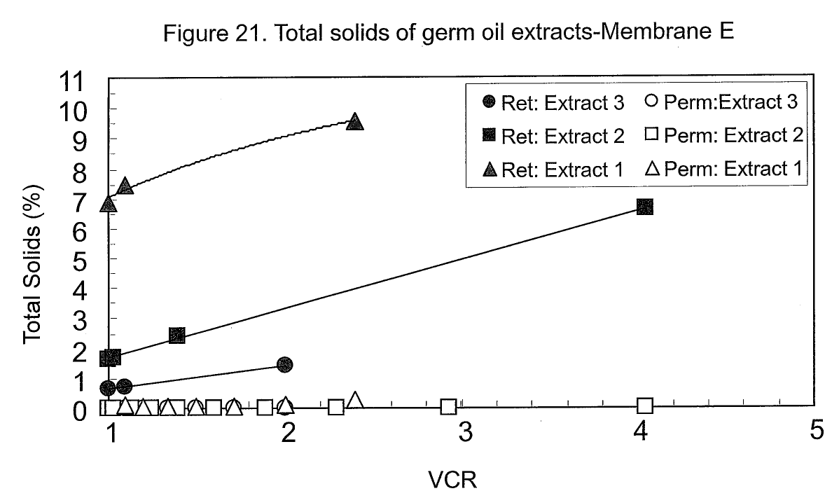

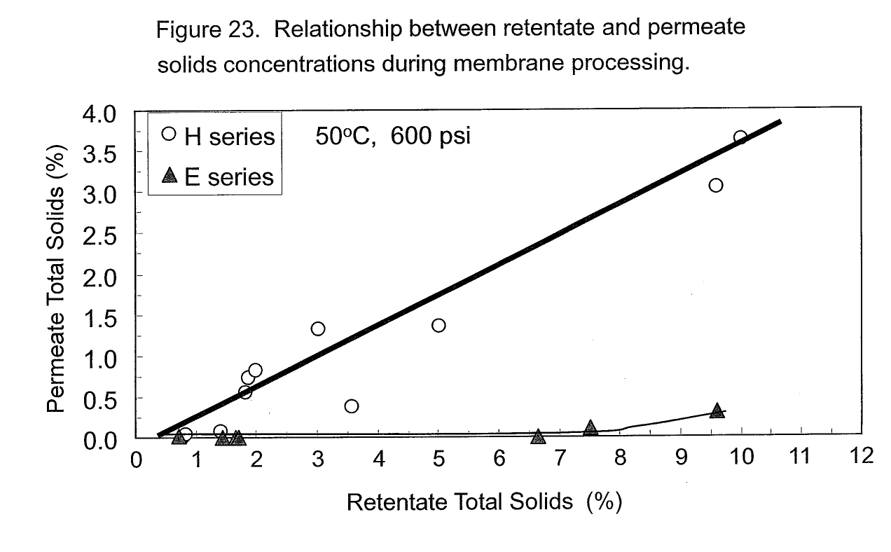

However, the final oil concentrations depended on the initial oil concentration as well as the rejection of oil (i.e., the separation properties of the particular membrane). Membrane H showed some leakage of the oil through into the permeate (FIG. 18) and the leakage rate was proportional to the concentration of solids/oil in the feed/retentate. For example, with 7-10% oil in the retentate, permeate oil/solids was 3-3.5%, With 2-5% solids in the retentate, permeate oil was 0.5-1%. With retentate solids of <1%, permeate oil was less than 0.1% (Extract 3 data not shown in FIG. 28). This is typical of membranes whose permeation is governed principally by a diffusion mechanism. On the other hand, Membrane E was a much tighter membrane and showed little or no passage of oil into the permeate (FIG. 21). This relative tightness of the pores is also reflected in the flux data. Membrane H (FIG. 17) had about 2-3 times higher flux than Membrane E (FIG. 20). The relationship between retentate and permeate solids is shown later in FIG. 23. Thus there has to be a balance between flux and oil yield and recovery when selecting membranes.

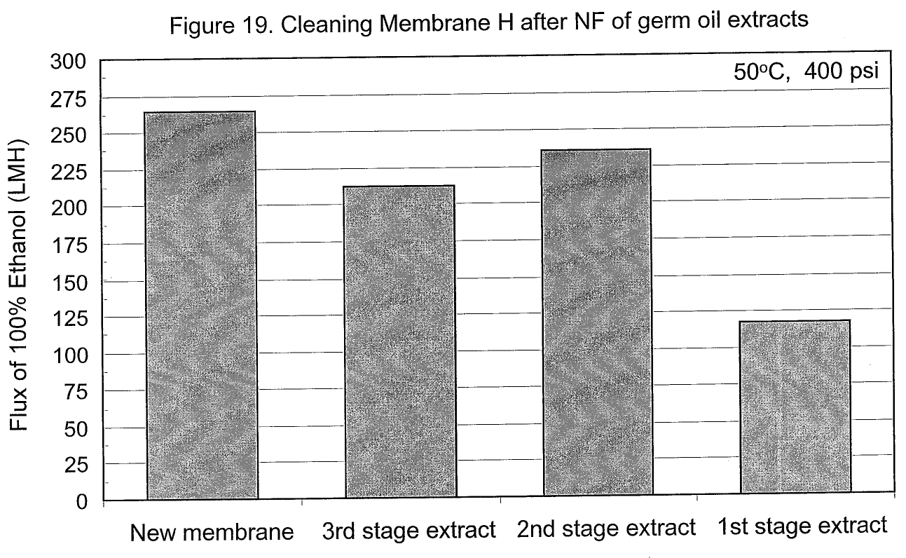

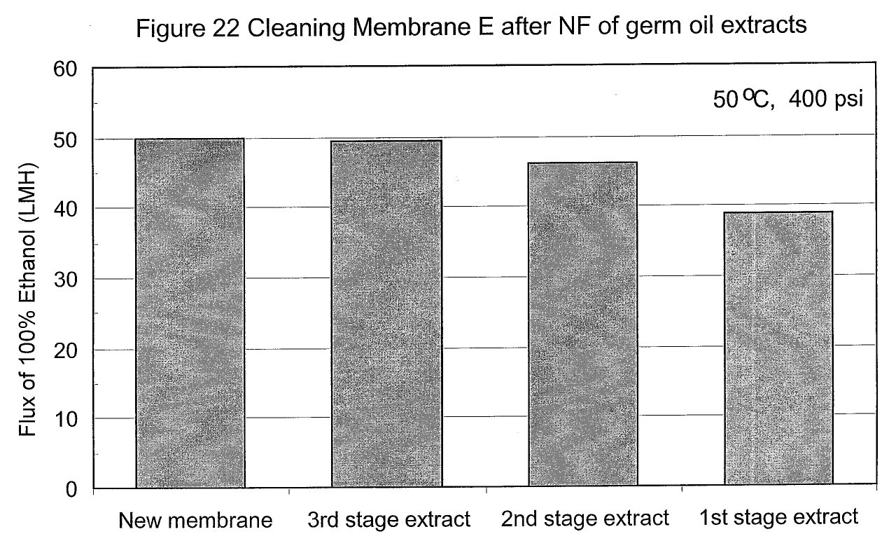

FIGS. 19 and 22 show membrane cleaning data. The “new” membrane data was obtained after conditioning and before first exposure of the membrane to the oil extracts. Each extract was treated with a different coupon of the same membrane. Cleaning membranes was more difficult with more concentrated extracts, as expected. Membrane E recovered clean solvent fluxes easier than Membrane H, perhaps because Membrane E was tighter (smaller pores) and allowed less passage of oil through its pores, thus minimizing pore plugging and making it easier to clean the membrane. Cleanability is also an important issue and must be considered when selecting membranes.

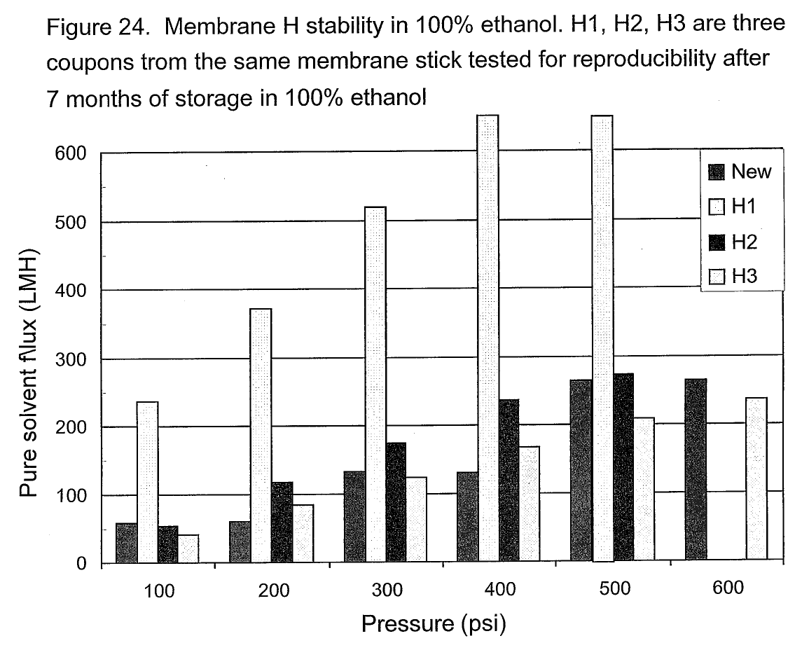

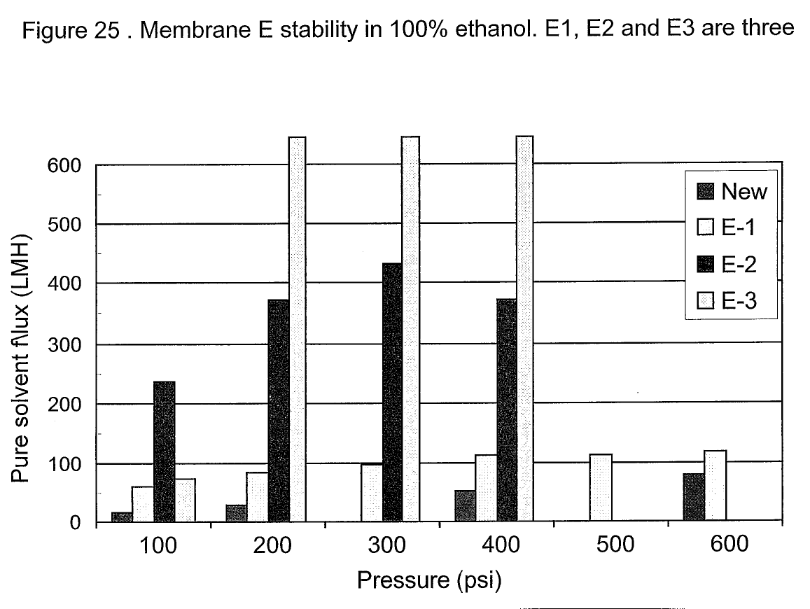

The stability of membranes upon exposure to ethanol was also studied. Three membrane coupons used for membrane concentration experiments were cleaned and stored in 100% ethanol in sealed containers under ambient conditions (25° C., atmospheric pressure). After 7 months of storage, the coupons were tested for flux under standard conditions. If they were stable, the fluxes would about be the same as when “new”. The results were quite variable as shown in FIGS. 24 and 25 which show flux-pressure relationships of the membranes when new vs. after storage. Two of the three coupons of Membrane H were quite stable, but one coupon (H1) appeared to collapse as indicated by the large increase in flux. Two Membrane E coupons were not stable (FIG. 25). Since membrane stability for at least one year is desirable, this phenomenon must be investigated further with more sophisticated methods.

The foregoing description and drawings comprise illustrative embodiments of the present inventions. The foregoing embodiments and the methods described herein may vary based on the ability, experience, and preference of those skilled in the art. For example, the separation of corn solids from the extraction mixture can be done by one or more of several methods including centrifugation, decanting, gravity settling, microlfitration and the like. Membrane filtration may include operations for the purpose of concentration, purification, clarification, and fractionation and include diafiltration as required. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A process for producing oil from corn germ, the process comprising:
a) extracting oil from corn germ by contacting an alcohol solvent with corn germ to form an extraction mixture containing the alcohol solvent, oil, and deoiled corn germ solids;
b) separating the deoiled corn germ solids in the extraction mixture to result in an extract containing the alcohol solvent and oil;
c) membrane filtering the extract to retain the oil in the retentate and passing the alcohol solvent into the permeate, said membrane filtering including nanofiltration or reverse osmosis; and
d) purifying the oil contained within the retentate.

2. The process of claim 1, wherein the alcohol solvent is composed of ethanol and water in the range from about 90% to about 100% ethanol, and the rest of the solvent being water.

3. The process of claim 1, wherein the alcohol solvent is composed of isopropanol and water in the range from about 90% to about 100% isopropanol and the rest of the solvent being water.

4. The process of claim 1, wherein the alcohol solvent is composed of isopropanol, ethanol and water in the range from about 90% to about 100% ethanol, about 5% to about 10% isopropanol and the rest of the solvent being water.

5. The process of claim 1, wherein the ratio of corn germ to alcohol solvent is from about 1:1 to about 1:10.

6. The process of claim 1 where the moisture content of the corn germ is 0-14% by weight.

7. The process of claim 1, wherein the step of membrane filtering the extract includes nanofiltration or reverse osmosis membranes with a molecular weight cut-off or separating capability such that compounds having a molecular weight in the range of from about 500 daltons to about 900 daltons are retained by the membrane and the alcohol solvent passes through the membrane into the permeate.

8. The process of claim 1, wherein the step of concentrating the oil contained within the retentate includes evaporation of the alcohol solvent.

9. The process of claim 8 further comprising the step of recycling alcohol solvent from said evaporation.

10. The process of claim 1, wherein the extraction step of contacting or mixing the alcohol solvent with the corn germ is performed at a temperature in the range from about 30° C. to about 90° C.

11. The process of claim 10, wherein the extraction step is performed at a temperature from about 60° C. to about 90° C.

12. The process of claim 1, wherein the extraction step is performed for a period of time in the range of from about 10 minutes to about 180 minutes.

13. The process of claim 1, further comprising the step of processing the permeate to recycle alcohol solvent.

14. The process of claim 13, wherein said processing the permeate comprises distillation.

15. The process of claim 13, wherein said processing the permeate comprises pervaporation.

16. A process for removing corn oil from corn germ, said process comprising:
a) fractionating whole corn into corn germ and de-germed corn;
b) extracting oil from corn germ by mixing an alcohol solvent with corn germ to form an extraction mixture containing the alcohol solvent, oil and deoiled corn germ solids;
c) separating the deoiled corn germ solids in the extraction mixture to result in an extract containing the alcohol solvent and oil;
d) membrane filtering the extract to retain the oil in the retentate and passing the alcohol solvent into the permeate, said membrane filtering including nanofiltration or reverse osmosis;
e) concentrating and purifying the oil contained within the retentate; and
f) processing the de-germed corn to produce other co-products.

17. The process of claim 16, wherein the de-germed corn solids are desolventized.

18. The process of claim 16 wherein the de-germed corn solids are processed to produce alcohol.

19. The process of claim 16, wherein the de-oiled germ solids are desolventized.

20. The process of claim 16 wherein the de-oiled germ solids are processed to produce alcohol.

21. The process of claim 16 wherein said alcohol is ethanol.

22. The process of claim 1 wherein the extraction is done in a batch or continuous mode or any combination thereof.

23. The process of claim 7, further comprising the step of processing the permeate to recycle alcohol solvent.

24. The process of claim 23, wherein said processing the permeate comprises distillation.

25. The process of claim 23, wherein said processing the permeate comprises pervaporation.

26. The process of claim 17, wherein the de-germed corn solids are processed to produce alcohol.

27. The process of claim 19, wherein the deoiled germ solids are processed to produce alcohol.

28. The process of claim 18, wherein said alcohol is ethanol.

29. The process of claim 20, wherein said alcohol is ethanol.

30. The process of claim 16, wherein the extraction is done in a batch or continuous mode or any combination thereof.
